(19) United States
(12) Patent Application Publication
(10) Pub. No.: US 2022/0290846 A1
(43) Pub. Date: Sep. 15, 2022

(54) QUICK-INSTALL SOFT BOX

(71) Applicant: SHENZHEN NICE PHOTOGRAPHIC EQUIP MENTCO.,LTD., Shenzhen (CN)

(72) Inventor: Guoyu Que, Shenzhen (CN)

(21) Appl. No.: 17/201,042

(22) Filed: Mar. 15, 2021

(51) Int. Cl. F21V 17/14; F21V 17/06

(52) U.S. Cl. CPC F21V 17/14; F21V 17/06; F21W 2131/406

(57) ABSTRACT

The utility model provides a quick-assembly soft light box. The quick-assembly soft light box comprises a bayonet, a chuck cover, a chuck seat, a plurality of rotating heads and a plurality of supporting strips, wherein a light source passes through the middle of the bayonet; the first surface of the chuck cover is connected with the edge of the bayonet; guide structures of the chuck seat are distributed along the edge circumference of the chuck seat, and the chuck seat is fixedly connected with the second surface of the chuck cover; first ends of the rotating heads are installed in the guide structures of the chuck seat, the rotating heads move in the guide structures, and the rotating heads have a first state perpendicular to the plane of the chuck seat and a second state parallel to the plane of the chuck seat; the first ends of the supporting strips are connected with second ends of the rotating heads, and second ends of the supporting strips are used for installing reflective cloth; the chuck seat is annular, the guide structures are distributed along the edge circumference of the chuck seat, and the rotating heads are installed in the guide structures. According to the technical solutions of the utility model, the problems in the prior art that the soft light box is tedious to assemble and inconvenient to use, and a buckle structure is not firm and is easy to trip are effectively solved.

### TECHNICAL FIELD

The invention relates to the technical field of soft light boxes, in particular to a quick-assembly soft light box.

### BACKGROUND

A soft light box is photographic equipment and is composed of four parts such as reflective cloth, soft light cloth, a steel wire frame and a bayonet. The soft light box cannot be used independently, and belongs to an accessory of a studio lamp. The soft light box is installed on the studio lamp, emitted light is softer, and light spots and shadows on photos can be eliminated during shooting.

In the prior art, there are many types of soft light boxes at present, but there are many disadvantages. Firstly, a buckle type soft light box is pressed with hands, the assembly process is complex, the soft light box is inconvenient to operate and use, and a buckle structure is not firm and is easy to trip; secondly, a traditional steel wire inserted umbrella supporting type soft light box is serious in middle shadow, and the lighting effect is influenced; and thirdly, the frame of an existing soft light box is basically of an alloy structure, so that the soft light box is heavy and not easy to carry.

### SUMMARY

The utility model mainly aims to provide a quick-assembly soft light box so as to solve the problems in the prior art that the soft light box is tedious to assemble and inconvenient to use, and a buckle structure is not firm and is easy to trip.

In order to achieve the purpose, the utility model provides a quick-assembly soft light box. The quick-assembly soft light box comprises a bayonet, a chuck cover, a chuck seat, a plurality of rotating heads and a plurality of supporting strips, wherein a light source passes through the middle of the bayonet; the first surface of the chuck cover is connected with the edge of the bayonet; the chuck seat comprises guide structures, the guide structures of the chuck seat are distributed along the edge circumference of the chuck seat, and the chuck seat is fixedly connected with the second surface of the chuck cover; first ends of the rotating heads are installed in the guide structures of the chuck seat, the rotating heads move in the guide structures, and the rotating heads have a first state perpendicular to the plane of the chuck seat and a second state parallel to the plane of the chuck seat; first ends of the supporting strips are connected with second ends of the rotating heads, and second ends of the supporting strips are used for installing reflective cloth; the chuck seat is annular, the guide structures are distributed along the edge circumference of the chuck seat, and the rotating heads are installed in the guide structures.

Further, each guide structure comprises a guide groove, a supporting part and an opening part, a first end of each guide groove is connected with the corresponding supporting part, and a second end of each guide groove is connected with the corresponding opening part.

Further, each rotating head comprises a spherical part and a hollow cylindrical part, each spherical part is connected with the corresponding hollow cylindrical part, each spherical part can horizontally move and rotate in the corresponding guide groove, and each hollow cylindrical part is connected with the corresponding supporting strip.

Further, the guide structures are cavities formed by the chuck seat and the chuck cover in a matched mode, and the cavities are matched with the rotating heads.

Further, each spherical part is matched with an inner cavity of the corresponding guide groove, the moving space of each spherical part is from a first end of the corresponding guide groove to a second end of the corresponding guide groove, and the rotating angle of each spherical part in the corresponding guide groove is 0-90 degrees.

Further, when the rotating angle of each spherical part along the corresponding guide groove is 0 degree and each spherical part is located at the second end of the corresponding guide groove, each hollow cylindrical part is located on the corresponding supporting part and is parallel to the plane where the chuck seat is located; when the rotating angle of each spherical part along the guide groove is 90 degrees and each spherical part is located at the first end of the corresponding guide groove, each hollow cylindrical part is located in the corresponding opening part and is perpendicular to the plane where the chuck seat is located.

Further, each supporting part comprises a groove, and each groove is matched with the appearance of the corresponding hollow cylindrical part.

Further, the supporting strips are glass fiber rods, the supporting strips are matched with the rotating heads, and the supporting strips are distributed in a circumferential array mode and used for supporting reflective cloth.

By applying the technical solutions of the utility model, when the device is assembled, the rotating heads are installed in the guide structures of the chuck seat, the chuck cover is installed at the upper part of the chuck seat, the supporting strips are connected with the rotating heads, the bayonet is clamped on the chuck cover, and the assembled supporting strips are respectively arranged in set fixing sleeves of the reflective cloth respectively in a sleeving mode so as to assemble a circular reflective box with the bayonet as a center of a circle, and the rotating heads are limited in the guide structures through the chuck seat and the chuck cover; by means of the structural design, a traditional pressing buckle type complex and tedious assembling process is improved, the buckle falling risk existing in a pressing buckle type is avoided, and the overall assembling process is convenient and fast.

When the device is used, the rotating heads are lifted to rotate and translate in the guide structures, when the positions of all the rotating heads are parallel to the plane of the chuck seat, it is indicated that the soft light box is opened, and at the moment, the supporting strips drive the reflective cloth to form a circular reflective box with the bayonet as the center; when the device is folded, the rotating heads are lifted to horizontally move and rotate along the guide structures, so that all the rotating heads are perpendicular to the plane of the chuck seat, and then all the rotating heads drive the supporting strips to fold the reflective cloth. The whole using and folding process is very convenient.

According to the technical solutions of the utility model, the problems in the prior art that the soft light box is tedious to assemble and inconvenient to use, and a buckle structure is not firm and is easy to trip are effectively solved.

### BRIEF DESCRIPTION OF THE DRAWINGS

Accompanying drawings, which form a part of the specification and are provided for further understanding of the utility model, show the preferred embodiments of the utility model, and explain the principle of the utility model together with the description, but not by way of limitation with regard to the utility model. In the accompanying drawings,

FIG. 1 is a schematic structural diagram of a using state according to the embodiment of a quick-assembly soft light box in the utility model;

FIG. 2 is an exploded schematic structural diagram of the embodiment in FIG. 1.

FIG. 3 is a partial enlarged drawing of part A in FIG. 2;

FIG. 4 is an upper visual angle schematic structural diagram of the embodiment in FIG. 1;

FIG. 5 is a structural enlarged drawing of part B in FIG. 4;

FIG. 6 is a schematic cross section of a using state of the embodiment in FIG. 1; and

FIG. 7 is a schematic cross section of a folding state of the embodiment in FIG. 1.

### REFERENCE SIGNS IN THE ACCOMPANYING DIAGRAMS

10, bayonet; 20, chuck cover; 30, chuck seat; 31, guide structure; 311, guide groove; 312, supporting part; 313, opening part; 40, rotating head; 41, spherical part; 42, hollow cylindrical part; and 50, supporting strip.

### DESCRIPTION OF THE EMBODIMENTS

It needs to be illustrated that under the compatible condition, the embodiments in this application and characteristics in the embodiments can be combined mutually. The utility model is described in detail below with reference to the accompanying drawings in conjunction with the embodiments.

It should be noted that the following detailed description is exemplary and aims to provide further description for the utility model. Except as otherwise noted, all techniques and scientific terms used in the utility model have same meanings generally understood by ordinary skill in the art in the utility model.

In order to facilitate description, spatially relative terms such as “over,” “above,” “on an upper surface” and “upper” may be used herein to describe a spatial positional relationship of one device or feature with other devices or features as shown in the figures. It should be understood that the spatially relative terms are intended to include different orientations in use or operation in addition to the orientation of the device described in the figures. For example, if a device in a figure is inverted, the device described as “above or over other devices or constructions” would then be positioned “blow or under the other devices or construction”. Therefore, the exemplary term “above” may include two orientations including “above” and “below”. The device may also be positioned (rotated by 90 degrees or at other orientations) in other different ways and the spatially relative descriptions used herein are interpreted accordingly.

At present, exemplary embodiments according to the present application are described in more detail with reference to the accompanying drawings. However, these exemplary embodiments may be embodied in many different forms and should not be construed as limited to only the embodiments set forth herein. It should be understood that these embodiments are provided so that the utility model is thorough and complete, and the concepts of these exemplary embodiments are fully conveyed to those skilled in the art, in the accompanying diagrams, the thicknesses of the layers and regions are expanded for clarity, and the same devices are represented by using the same reference signs, so that description of the devices is omitted.

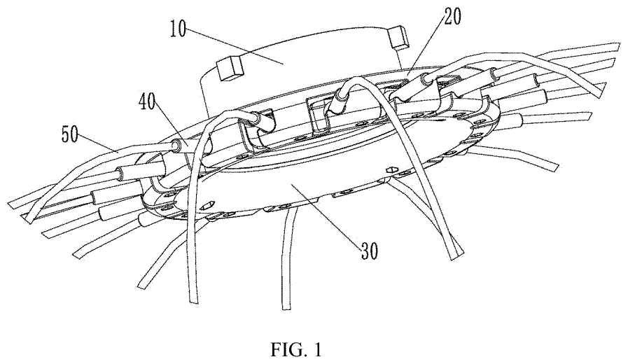

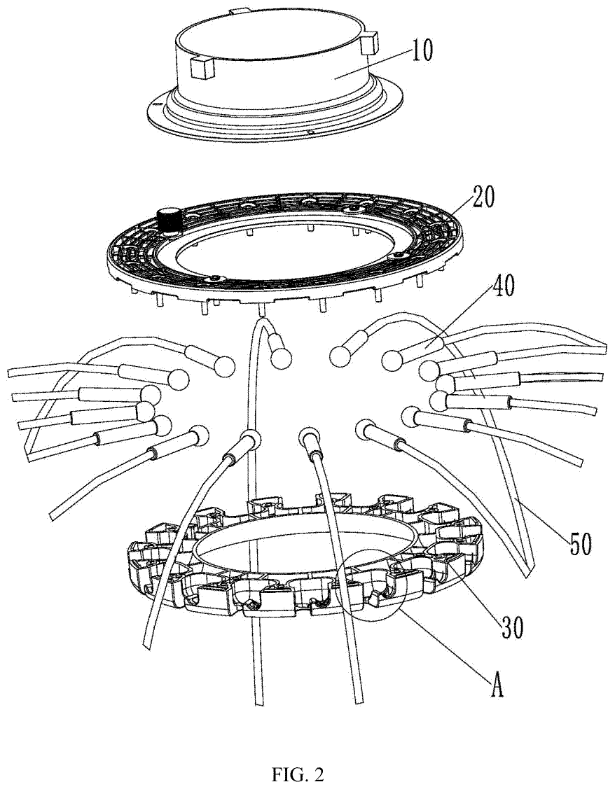

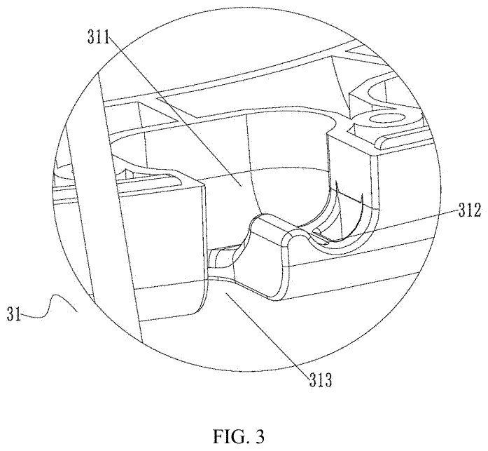

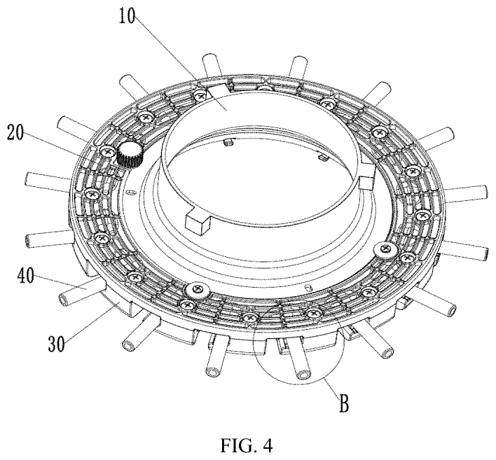

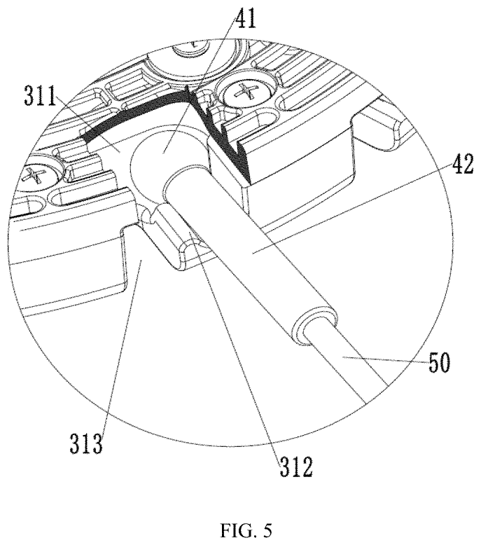

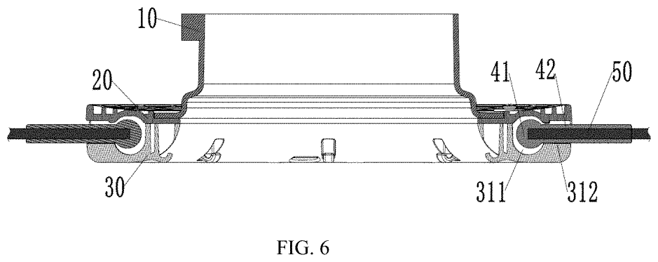

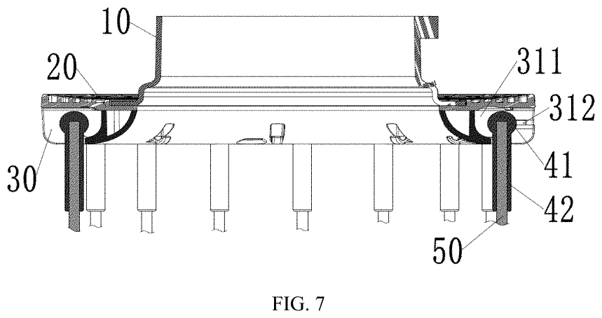

As shown in FIG. 1 to FIG. 7, a quick-assembly soft light box in the embodiment comprises a bayonet 10, a chuck cover 20, a chuck seat 30, a plurality of rotating heads 40 and a plurality of supporting strips 50, wherein a light source passes through the middle of the bayonet 10; the first surface of the chuck cover 20 is connected with the edge of the bayonet 10; the chuck seat 30 comprises guide structures 31, the guide structures 31 are distributed along the edge circumference of the chuck seat 30, and the chuck seat 30 is fixedly connected with the second surface of the chuck cover 20; first ends of the rotating heads 40 are installed in the guide structures 31 of the chuck seat 30, the rotating heads 40 move in the guide structures 31, and the rotating heads 40 have a first state perpendicular to the plane of the chuck seat 30 and a second state parallel to the plane of the chuck seat 30; first ends of the supporting strips 50 are connected with second ends of the rotating heads 40, and second ends of the supporting strips 50 are used for installing reflective cloth; the chuck seat 30 is annular, the guide structures 31 are distributed along the edge circumference of the chuck seat 30, and the rotating heads 40 are installed in the guide structures 31.

By applying the technical solutions of the utility model, when the device is assembled, the rotating heads 40 are installed in the guide structures 31 of the chuck seat 30, the chuck cover 20 is installed at the upper part of the chuck seat 30, the supporting strips 50 are connected with the rotating heads 40, the bayonet 10 is clamped on the chuck cover 20, and the assembled supporting strips 50 are respectively arranged in set fixing sleeves of the reflective cloth respectively in a sleeving mode so as to assemble a circular reflective box with the bayonet 10 as a center of a circle, and the rotating heads 40 are limited in the guide structures 31 through the chuck seat 30 and the chuck cover 20; by means of the structural design, a traditional pressing buckle type complex and tedious assembling process is improved, the buckle falling risk existing in a pressing buckle type is avoided, and the overall assembling process is convenient and fast. When the device is used, the rotating heads 40 are lifted to rotate and translate in the guide structures 31, when the positions of all the rotating heads 40 are parallel to the plane of the chuck seat 30, it is indicated that the soft light box is opened, and at the moment, the supporting strips 50 drive the reflective cloth to form a circular reflective box with the bayonet as the center; when the device is folded, the rotating heads 40 are lifted to horizontally move and rotate along the guide structures 31, so that all the rotating heads 40 are perpendicular to the plane of the chuck seat 30, and then all the rotating heads 40 drive the supporting strips 50 to fold the reflective cloth. The whole using and folding process is very convenient. According to the technical solutions of the utility model, the problems in the prior art that the soft light box is tedious to assemble and inconvenient to use, and a buckle structure is not firm and is easy to trip are effectively solved.

As shown in FIG. 1 to FIG. 7, in the technical solutions of the embodiment, each guide structure 31 comprises a guide groove 311, a supporting part 312 and an opening part 313, a first end of each guide groove 311 is connected with the corresponding supporting part 312, and a second end of each guide groove 311 is connected with the corresponding opening part 313. The guide grooves 311 are used for rotation and translation of the rotating heads 40; the supporting parts 312 are used for supporting the rotating heads 40, so that the rotating heads 40 are kept in a state of being parallel to the plane of the chuck seat 30; and the opening parts 313 are used for storing the folded rotating heads 40, so that the rotating heads 40 are kept in a state of being perpendicular to the plane of the chuck seat 30. By means of the structural arrangement, the rotating heads 40 can move more flexibly, and the operation is more convenient and simpler.

As shown in FIG. 1 to FIG. 7, in the technical solutions of the embodiment, each rotating head 40 comprises a spherical part 41 and a hollow cylindrical part 42, each spherical part 41 is connected with the corresponding hollow cylindrical part 42, each spherical part 41 can horizontally move and rotate in the corresponding guide groove 311, and each hollow cylindrical part 42 is connected with the corresponding supporting strip 50. The spherical parts 41 are spherical, so that the spherical parts rotate and translate in the guide grooves 311 conveniently. The hollow cylindrical parts 42 are used for installing the supporting strips 50.

It should be further explained that when the soft light box is used, the rotating heads 40 are lifted, the spherical parts 41 are rotated in the guide grooves 311, the hollow cylindrical parts 42 are lifted from the opening parts 313, the hollow cylindrical parts 42 are parallel to the plane of the chuck seat 30, at the moment, the spherical parts 41 are moved to the first ends of the guide grooves 311 from the second ends of the guide grooves 311, and then the hollow cylindrical parts 42 are placed on the supporting parts 312, so that the process from folding to unfolding the supporting strips 50 is completed. During folding, the rotating heads 40 are lifted, the hollow cylindrical parts 42 are lifted from the opening parts 313, the hollow cylindrical parts 42 are parallel to the plane of the chuck seat 30, at the moment, the spherical parts 41 are moved to the second ends of the guide grooves from the first ends of the guide grooves 311, then the spherical parts 41 are rotated in the guide grooves 311, and then the hollow cylindrical parts 42 are placed in the opening parts 313, so that the process from folding to unfolding the supporting strips 50 is completed. In the whole process, the rotating heads 40 do not fall off, and the operation is simple and convenient.

As shown in FIG. 1 to FIG. 7, in the technical solutions of the embodiment, the guide structures 31 are cavities formed by the chuck seat 30 and the chuck cover 20 in a matched mode, and the cavities are matched with the rotating heads 40.

As shown in FIG. 1 to FIG. 7, in the technical solutions of the embodiment, each spherical part 41 is matched with an inner cavity of the corresponding guide groove 311, the moving space of each spherical part 41 is from a first end of the corresponding guide groove 311 to a second end of the corresponding guide groove 311, and the rotating angle of each spherical part 41 in the corresponding guide groove 311 is 0-90 degrees.

As shown in FIG. 1 to FIG. 7, in the technical solutions of the embodiment, when the rotating angle of each spherical part 41 along the corresponding guide groove 311 is 0 degree and each spherical part 41 is located at the second end of the corresponding guide groove 311, each hollow cylindrical part 42 is located on the corresponding supporting part 312 and is parallel to the plane where the chuck seat 30 is located; when the rotating angle of each spherical part 41 along the guide groove 311 is 90 degrees and each spherical part 41 is located at the first end of the corresponding guide groove 311, each hollow cylindrical part 42 is located in the corresponding opening part 313 and is perpendicular to the plane where the chuck seat 30 is located.

As shown in FIG. 1 to FIG. 7, in the technical solutions of the embodiment, each supporting part 312 comprises a groove, and each groove is matched with the appearance of the corresponding hollow cylindrical part 42. The grooves enable the hollow cylindrical parts 42 to keep stable positions in the supporting parts 312, so that the soft light box is more stable in use.

As shown in FIG. 1 to FIG. 7, in the technical solutions of the embodiment, the supporting strips 50 are glass fiber rods, the supporting strips 50 are matched with the rotating heads 40, and the supporting strips 50 are distributed in a circumferential array mode and used for supporting the reflective cloth. The glass fiber rods are extremely good in toughness, the bulkiness of traditional metal is improved through the technology, and the glass fiber rods are convenient for a user to carry.

It needs to be noted that the chuck cover 20, the chuck seat 30 and the rotating heads 40 are formed by high-temperature-resistant engineering plastic in an injection molding mode, and the weight is further reduced. Besides, small and light material components are used, the structure is compact, and therefore the problem that the shadow in the middle of a traditional steel wire inserted umbrella supporting type soft light box is serious is solved.

It needs to be noted that the terms used herein just describe the specific mode of execution, but not expect to limit the exemplary modes of execution in the disclosure. It should be understood that the singular forms “a”, “an”, and “the” include plural referents unless the context clearly dictates otherwise. Moreover, it should be understood that the terms “contain” and/or “comprise” used in the specification indicate characteristics, steps, operations, devices, assemblies and/or their combination.

It needs to be noted that in the specification, claims, and accompanying drawings of this application, the terms such as “first” and “second” are intended to distinguish between similar objects but do not necessarily indicate a specific order or sequence. It should be understood that the data used in this way is interchangeable in appropriate circumstances so that the embodiments of this application described herein can be implemented in other orders than the order illustrated or described herein. In addition, the terms “include”, “have”, and any other variant thereof are intended to cover a non-exclusive inclusion. For example, a process, method, system, product, or device that includes a list of steps or units is not necessarily limited to those steps or units that are expressly listed, but may include other steps or units that are not expressly listed or are inherent to the process, method, system, product, or device.

The foregoing descriptions are merely exemplary embodiments of the utility model, but are not intended to limit the utility model, and for the skill in the art, the utility model can be of various modifications and changes. Any modification, equivalent replacement, or improvement made without departing from the spirit and principle of the utility model shall fall within the protection scope of the utility model.

What is claimed is:

1. A quick-assembly soft light box, characterized by comprising:
a bayonet (10), the middle of which a light source passing through;
a chuck cover (20), the first surface of which being connected with the edge of the bayonet (10);
a chuck seat (30), the chuck seat (30) comprising guide structures (31), the guide structures (31) being distributed along the edge circumference of the chuck seat (30), and the chuck seat (30) being fixedly connected with the second surface of the chuck cover (20);
a plurality of rotating heads (4), first ends of the rotating heads (40) being installed in the guide structures (31) of the chuck seat (30), the rotating heads (40) moving in the guide structures (31), and the rotating heads (40) having a first state perpendicular to the plane of the chuck seat (3) and a second state parallel to the plane of the chuck seat (30);
a plurality of supporting strips (50), the first ends of the supporting strips (50) being connected with second ends of the rotating heads (40), and second ends of the supporting strips (50) being used for installing reflective cloth;
the chuck seat (30) being annular, the guide structures (31) being distributed along the edge circumference of the chuck seat (30), and the rotating heads (40) being installed in the guide structures (31).

2. The quick-assembly soft light box according to claim 1, characterized in that each guide structure (31) comprises a guide groove (311), a supporting part (312) and an opening part (313), a first end of each guide groove (311) is connected with the corresponding supporting part (312), and a second end of each guide groove (311) is connected with the corresponding opening part (313).

3. The quick-assembly soft light box according to claim 2, characterized in that each rotating head (40) comprises a spherical part (41) and a hollow cylindrical part (42), each spherical part (41) is connected with the corresponding hollow cylindrical part (42), each spherical part (41) can horizontally move and rotate in the corresponding guide groove (311), and each hollow cylindrical part (42) is connected with the corresponding supporting strip (50).

4. The quick-assembly soft light box according to claim 1, characterized in that the guide structures (31) are cavities formed by the chuck seat (30) and the chuck cover (20) in a matched mode, and the cavities are matched with the rotating heads (40).

5. The quick-assembly soft light box according to claim 3, characterized in that each spherical part (41) is matched with an inner cavity of the corresponding guide groove (311), the moving space of each spherical part (41) is from a first end of the corresponding guide groove (311) to a second end of the corresponding guide groove (311), and the rotating angle of each spherical part (41) in the corresponding guide groove (311) is 0-90 degrees.

6. The quick-assembly soft light box according to claim 5, characterized in that when the rotating angle of each spherical part (41) along the corresponding guide groove (311) is 0 degree and each spherical part (41) is located at the second end of the corresponding guide groove (311), each hollow cylindrical part (42) is located on the corresponding supporting part (312) and is parallel to the plane where the chuck seat (30) is located; when the rotating angle of each spherical part (41) along the guide groove (311) is 90 degrees and each spherical part (41) is located at the first end of the corresponding guide groove (311), each hollow cylindrical part (42) is located in the corresponding opening part (313) and is perpendicular to the plane where the chuck seat (30) is located.

7. The quick-assembly soft light box according to claim 5, characterized in that each supporting part (312) comprises a groove, and each groove is matched with the appearance of the corresponding hollow cylindrical part (42).

8. The quick-assembly soft light box according to claim 1, characterized in that the supporting strips (50) are glass fiber rods, the supporting strips (50) are matched with the rotating heads (40), and the supporting strips (50) are distributed in a circumferential array mode and used for supporting reflective cloth.

9. The quick-assembly soft light box according to claim 6, characterized in that each supporting part (312) comprises a groove, and each groove is matched with the appearance of the corresponding hollow cylindrical part (42).
